(19) United States
(12) Patent Application Publication
(10) Pub. No.: US 2007/0270273 A1
(43) Pub. Date: Nov. 22, 2007

(54) METHOD AND APPARATUS FOR FAST CELL SEARCH

(75) Inventors: Masaya Fukuta, Yokohama-shi (JP); Hidenori Akita, Higashimurayama-shi (JP); Hiroshi Hayashi, Nishitokyo-Shi (JP)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/383,971

(22) Filed: May 18, 2006

(51) Int. Cl. F16H 37/08

(52) U.S. Cl. 475/206

(57) ABSTRACT

Reference sequences are constructed from distinct “classes” of GCL sequences that have an optimal cyclic cross correlation property. The fast cell search method disclosed detects the “class indices” with simple processing. In a system deployment that uniquely maps sequences of certain class indices along with a circular shift amount in time domain to certain cells/cell IDs, the identification of a sequence index, and its circular shift will therefore provide an identification of the cell ID.

### FIELD OF THE INVENTION

The present invention relates generally to fast cell search, and in particular to a method and apparatus for fast identification of a service cell or sector during initial or periodic access, or handover in a mobile communication system.

### BACKGROUND OF THE INVENTION

In a mobile cellular network, the geographical coverage area is divided into many cells, each of which is served by a base station (BS). Each cell can also be further divided into a number of sectors. When a mobile station (MS) is powered up, it needs to search for a BS to register with. Also, when the MS finds out that the signal from the current serving cell becomes weak, it should prepare for a handover to another cell/sector. Because of this, the MS is required to search for a good BS for communication. The ability to quickly identify a BS for initial registration or handover is important for reducing the processing complexity and thus lowering the power consumption.

The cell search function is often performed based on a cell-specific reference signal (or preamble) transmitted periodically on a synchronization channel (SCH). A straightforward method is to perform an exhaustive search by trying to detect each reference signal and then determine the best BS. There are two important criteria when determining reference sequences for cells or sectors. First, the reference sequences should allow good channel estimation to all the users within its service area, which is often obtained through a correlation process with the reference of the desired cell. In addition, since a mobile will receive signals sent from other sectors or cells, a good cross correlation between reference signals is important to minimize the interference effect on channel estimation to the desired cell.

Just like auto-correlation, the cross-correlation between two sequences is a sequence itself corresponding to different relative shifts. Precisely, the cross-correlation at shift-d is defined as the result of summing over all entries after an element-wise multiplication between a sequence and another sequence that is conjugated and shifted by d entries with respect to the first sequence. “Good” cross correlation means that the cross correlation values at all shifts are as even as possible so that after correlating with the desired reference sequence, the interference can be evenly distributed and thus the desired channel can be estimated more reliably. Minimization of the maximal cross-correlation values at all shifts, which is reached when they are all equal, is refer to as “optimal” cross correlation.

Prior-art techniques, such as those described in US Patent Application Publication No. 2006/0039451 A1, (which is incorporated by reference herein) describe the use of reference sequences that are constructed from distinct “classes” of a Generalized Chirp-Like (GCL) sequence. By assigning a base station a particular index of a GCL sequence, the identification of a sequence index will therefore provide the identification of the base station.

While using GCL sequences does provide for superior reference signals, there can only exist N_{g}−1 sequences to utilize in a communication system when the length of the GCL sequences being used is N_{g}. Typical communication systems are required to provide more than 512 cell identifications. This requirement would require large GCL sequences to accommodate 512 unique GCL sequences. This would greatly increase system overhead. Therefore, a need exists for a method and apparatus for fast cell search in a communication system that utilizes GCL sequences, and yet has lower overhead for communication systems with large numbers of cell identifications.

### BRIEF DESCRIPTION OF THE DRAWINGS

FIG. 1 is a block diagram of a communication system.

FIG. 2 illustrates reference signal transmission for the communication system of FIG. 1.

FIG. 3 illustrates a primary synchronization channel and a secondary synchronization channel for the communication system of FIG. 1.

FIG. 4 is a block diagram of a transmitter transmitting a primary synchronization channel and a secondary synchronization channel.

FIG. 5 is a block diagram of receiver designed to identify a sequence index (u) and a circular shift index (m).

FIG. 6 is a block diagram of a sequence index (u) & a circular shift index (m) detector.

FIG. 7 is a block diagram of a sequence index (u) & a circular shift index (m) detector.

FIG. 8 is a block diagram of a transmitter.

FIG. 9 is a block diagram of a receiver.

FIG. 10 is a flow chart showing operation of a transmitter.

FIG. 11 is a flow chart showing operation of a receiver.

FIG. 12 is a flow chart showing operation of a receiver.

FIG. 13 is a flow chart showing operation of a transmitter.

FIG. 14 is a flow chart showing operation of a receiver.

### DETAILED DESCRIPTION OF THE DRAWINGS

To address the above-mentioned need, a method and apparatus for fast cell search based on a chirp reference signal transmission is disclosed herein. In particular, reference sequences are constructed from distinct “classes” of GCL sequences that have an optimal cyclic cross correlation property. The fast cell search method disclosed detects the “class indices” with simple processing. In a system deployment that uniquely maps sequences of certain class indices along with a circular shift amount in time domain to certain cells/cell IDs, the identification of a sequence index, and its circular shift will therefore provide an identification of the cell ID (transmitter).

The present invention encompasses a method for fast cell search. The method comprises the steps of receiving a Generalized Chirp-Like (GCL) sequence from a transmitter, determining a GCL index from the GCL sequence, and determining a circular shift of a GCL sequence. A transmitter identification is then determined based on the GCL index and the circular shift of the GCL sequence.

The present invention additionally encompasses an apparatus comprising a receiver receiving a Generalized Chirp-Like (GCL) sequence from a transmitter, a sequence index and circular shift detector determining a GCL index and a circular shift of the GCL sequence, and base identification circuitry determining a transmitter identification based on the GCL index and the circular shift of the GCL sequence.

The present invention additionally encompasses a method comprising the steps of circularly shifting a GCL sequence having a specific index and transmitting the circularly-shifted GCL sequence with the specific index, wherein a unique combination of the index and the circular shift uniquely identifies a transmitter.

The present invention additionally encompasses an apparatus comprising a circular shifter circularly shifting a GCL sequence having a specific index, and a transmitter transmitting the circularly-shifted GCL sequence with the specific index, wherein a unique combination of the index and the circular shift uniquely identifies a transmitter.

The present invention additionally encompasses a method for fast cell search. The method comprises the steps of receiving a Generalized Chirp-Like (GCL) sequence from a transmitter, determining a GCL index from the GCL sequence, and determining a circular shift of a GCL sequence. Information such as system bandwidth, broadcast channel bandwidth, a number of transmission antennas, and mobile unit patterns is determined based on the GCL index and the circular shift of the GCL sequence.

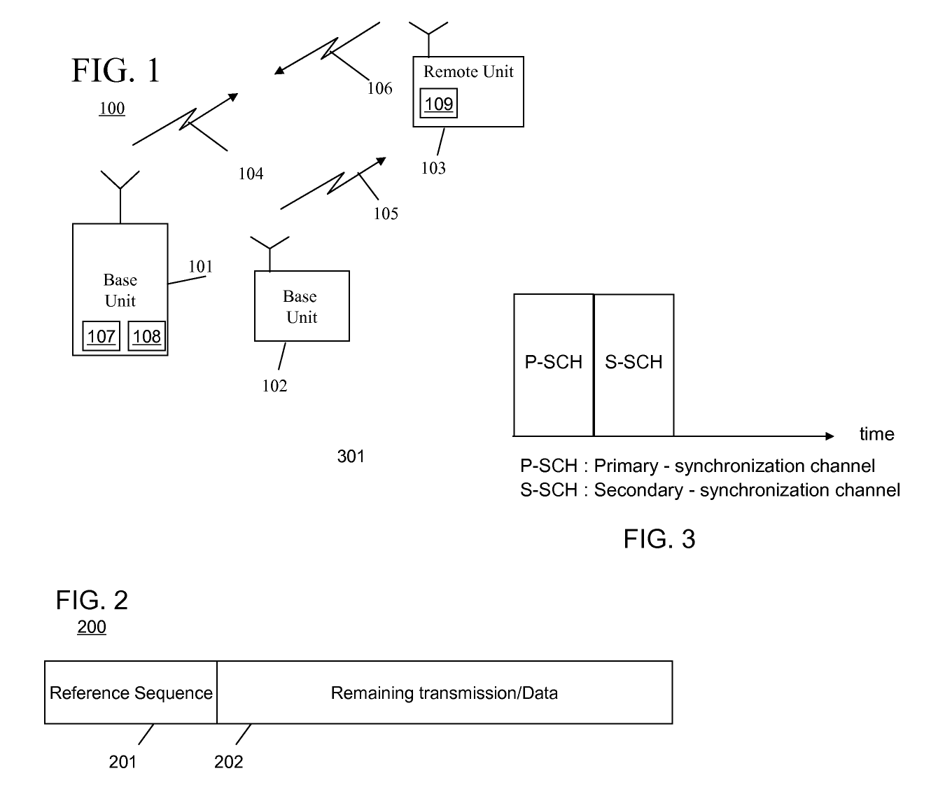

Turning now to the drawings, where like numerals designate like components, FIG. 1 is a block diagram of communication system 100 that utilizes reference transmissions. Communication system utilizes an Orthogonal Frequency Division Multiplexing (OFDM) protocol; however in alternate embodiments communication system 100 may utilize other digital cellular communication system protocols such as a Code Division Multiple Access (CDMA) system protocol, a Frequency Division Multiple Access (FDMA) system protocol, a Spatial Division Multiple Access (SDMA) system protocol or a Time Division Multiple Access (TDMA) system protocol, or various combinations thereof.

As shown, communication system 100 includes base unit 101 and 102, and remote unit 103. A base unit or a remote unit may also be referred to more generally as a communication unit. The remote units may also be referred to as mobile units. A base unit comprises a transmit and receive unit that serves a number of remote units within a sector. As known in the art, the entire physical area served by the communication network may be divided into cells, and each cell may comprise one or more sectors.

When multiple antennas are used to serve each sector to provide various advanced communication modes (e.g., adaptive beamforming, transmit diversity, transmit SDMA, and multiple stream transmission, etc.), multiple base units can be deployed. These base units within a sector may be highly integrated and may share various hardware and software components. For example, all base units co-located together to serve a cell can constitute what is traditionally known as a base station. Base units 101 and 102 transmit downlink communication signals 104 and 105 to serving remote units on at least a portion of the same resources (time, frequency, or both). Remote unit 103 communicates with one or more base units 101 and 102 via uplink communication signal 106. A communication unit that is transmitting may be referred to as a source communication unit. A communication unit that is receiving may be referred to as a destination or target communication unit.

It should be noted that while only two base units and a single remote unit are illustrated in FIG. 1, one of ordinary skill in the art will recognize that typical communication systems comprise many base units in simultaneous communication with many remote units. It should also be noted that while the present invention is described primarily for the case of downlink transmission from multiple base units to multiple remote units for simplicity, the invention is also applicable to uplink transmissions from multiple remote units to multiple base units. It is contemplated that network elements within communication system 100 are configured in well known manners with processors, memories, instruction sets, and the like, which function in any suitable manner to perform the function set forth herein.

As discussed above, reference assisted modulation is commonly used to aid in many functions such as channel estimation and cell identification. With this in mind, base units 101 and 102 transmit reference sequences at known time intervals as part of their downlink transmissions. Remote unit 103, knowing the set of sequences that different cells can use and the time interval, utilizes this information in cell search and channel estimation. Such a reference transmission scheme is illustrated in FIG. 2. As shown, downlink transmissions 200 from base units 101 and 102 typically comprise reference sequence 201 followed by remaining transmission 202. The same or a different sequence can show up one or multiple times during the remaining transmission 202. Thus, each base unit within communication system 100 comprises a transmitter 107 that transmits one or more reference sequences along with data channel circuitry 108 transmitting data. In a similar manner, each remote unit 103 within communication system 100 comprises sequence index detector and circular shift detector 109.

It should be noted that although FIG. 2 shows reference sequence 201 existing at the beginning of a transmission, in various embodiments of the present invention, the reference channel circuitry may include reference sequence 201 anywhere within downlink transmission 200, and additionally may be transmitted on a separate channel. Remaining transmission 202 typically comprises transmissions such as, but not limited to, sending information that the receiver needs to know before performing demodulation/decoding (so called control information) and actual information targeted to the user (user data).

As discussed above, it is important for any reference sequence to have optimal cross-correlation. With this in mind, communication system 100 utilizes reference sequences constructed from distinct “classes” of chirp sequences with optimal cyclic cross-correlation. The construction of such reference sequences is described below. In order to increase the amount of unique base unit (cell/sector) identifications, a unique circular shift of a GCL sequence is utilized to identify the base unit. Thus, a first base unit may be utilizing a GCL sequence having a first circular shift amount for identification, while a second base unit may be utilizing the same GCL sequence having a second circular shift amount for identification.

In one embodiment, the time domain reference signal is an Orthogonal Frequency Division Multiplexing (OFDM) symbol that is based on N-point FFT. A set of length-Nₚ sequences are assigned to base units in communication system 100 as the frequency-domain reference sequence (i.e., the entries of the sequence will be assigned onto a set of Nₚ (Nₚ<=N) reference subcarriers in the frequency domain). The spacing of these reference subcarriers is preferably equal (e.g., 0, 1, 2, etc. in subcarrier(s)). The final reference sequences transmitted in the time domain can be cyclically extended where the cyclic extension is typically longer than the expected maximum delay spread of the channel (L_{D}). In this case, the final sequence sent has a length equal to the sum of N and the cyclic extension length L_{CP}. The cyclic extension can comprise a prefix, postfix, or a combination of a prefix and a postfix. The cyclic extension is an inherent part of the OFDM communication system. The inserted cyclic prefix makes the ordinary auto- or cross-correlation appear as a cyclic correlation at any shift that ranges from 0 to L_{CP}. If no cyclic prefix is inserted, the ordinary correlation is approximately equal to the cyclic correlation if the shift is much smaller than the reference sequence length.

The construction of the frequency domain reference sequences depends on at least three factors, namely, a desired number of reference sequences needed in a network (K), a number of circular-shift indices (M), and a desired reference length (Nₚ). In fact, the number of reference sequences available that has the optimal cyclic cross-correlation of P−1 where P is the smallest prime factor of Nₚ other than “1” after factoring Nₚ into the product of two or more prime numbers including “1”. For example, the maximum value that P can be is Nₚ−1 when Nₚ is a prime number. But when Nₚ is not a prime number, the number of reference sequences often will be smaller than the desired number K. In order to obtain a maximum number of sequences, the reference sequence will be constructed by starting with a sequence whose length N_{G} is a prime number and then performing modifications. In the preferred embodiment, one of the following two modifications is used:
1. Choose N_{G} to be the smallest prime number that is greater than Nₚ and generate the sequence set. Truncate the sequences in the set to Nₚ; or
2. Choose N_{G} to be the largest prime number that is smaller than Nₚ and generate the sequence set. Repeat the beginning elements of each sequence in the set to append at the end to reach the desired length Nₚ.

The above design of requiring N_{G} to be a prime number will give a set of N_{G}−1 sequences that has ideal auto correlation and optimal cross correlation. However, if only a smaller number of sequences are needed, N_{G} does not need to be a prime number as long as the smallest prime factor of N_{G} excluding “1” is larger than K.

When a modification such as truncating or inserting is used, the cross-correlation will not be precisely optimal anymore. However, the auto- and cross-correlation properties are still acceptable. Further modifications to the truncated/extended sequences may also be applied, such as applying a unitary transform to them.

It should also be noted that while only sequence truncation and cyclic extension were described above, in alternate embodiments of the present invention there exist other ways to modify the GCL sequences to obtain the final sequences of the desired length. Such modifications include, but are not limited to extending with arbitrary symbols, shortening by puncturing, etc. Again, further modifications to the extended/punctured sequences may also be applied, such as applying a unitary transform to them.

As discussed above, in the preferred embodiment of the present invention Generalized Chirp-Like (GCL) sequences are utilized for constructing reference sequences. There are a number of “classes” of GCL sequences and if the classes are chosen carefully (see GCL property below); sequences with those chosen classes will have optimal cross-correlation and ideal autocorrelation. Class-u GCL sequence (S) of length N_{G} are defined as:

Sᵤ=(aᵤ(0)b,aᵤ(1)b, . . . ,aᵤ(N_{G}−1)b), (1)

where b can be any complex scalar of unit amplitude and

$${a}_{u} ( k ) = exp ( - j2π u \frac{k ( k + 1 ) / 2 + qk}{{N}_{G}} ) , \qquad ( 2 )$$

where,
u=1, . . . N_{G}−1 is known as the “class” of the GCL sequence,
k=0, 1, . . . N_{G}−1 are the indices of the entries in a sequence,
q=any integer.

Each class of GCL sequence can have infinite number of sequences depending on the particular choice of q and b, but only one sequence out of each class is used to construct one reference sequence. Notice that each class index “u” produces a different phase ramp characteristic over the elements of the sequence (i.e., over the “k” values).

It should also be noted that if an N_{G}-point DFT (Discrete Fourier Transform) or IDFT (inverse DFT) is taken on each GCL sequence, the member sequences of the new set also have optimal cyclic cross-correlation and ideal autocorrelation, regardless of whether or not the new set can be represented in the form of (1) and (2). In fact, sequences formed by applying a matrix transformation on the GCL sequences also have optimal cyclic cross-correlation and ideal autocorrelation as long as the matrix transformation is unitary. For example, the N_{G}-point DFT/IDFT operation is equivalent to a size-N_{G} matrix transformation where the matrix is an N_{G} by N_{G} unitary matrix. As a result, sequences formed based on unitary transformations performed on the GCL sequences still fall within the scope of the invention, because the final sequences are still constructed from GCL sequences. That is, the final sequences are substantially based on (but are not necessarily equal to) the GCL sequences.

If N_{G} is a prime number, the cross-correlation between any two sequences of distinct “class” is optimal and there will be N_{G}−1 sequences (“classes”) in the set. When a modification such as truncating or inserting is used, the modified reference sequence can be referred to as nearly-optimal reference sequences that are constructed from GCL sequences.

The integer “u” is the GCL sequence index. This sequence index is assigned to each cell. N_{G} in the equation is the length of the GCL sequence. A total of N_{G}−1 different sequences are available for use in different cells. N_{G} is a prime number equal or near the needed sequence length. If the needed sequence length is not a prime number, the next-largest prime number can be used for N_{G} and the resulting GCL sequence can be truncated to the desired length Nₚ.

If the OFDM symbol with the GCL sequence in the time domain is denoted by:

{sᵤ(n)}=IDFT({Sᵤ(k)})

where
u=1, . . . N_{G}−1 is known as the “class” of the GCL sequence,
n=0, . . . Nₚ−1 is known as time domain sample, where Nₚ-points IDFT is assumed, and
k=0, 1, . . . Nₚ−1 are the indices of the subcarriers in a frequency domain sequence.

The GCL symbol circularly shifted by “m*Q” in time domain is denoted by the following equation:

{sᵤ^{m}(n)}={sᵤ(n−m×Q)}

where, m=0, . . . M−1 is known as circular shift index, and “Q” is circular shift unit amount, “M” is available number of circular shift indices.

It should be noted that circular shifting may occur by multiplying the GCL sequence by complex exponential with a frequency in the frequency domain. In this case, the GCL symbol, which a complex exponential with frequency “m*Q” is multiplied, is denoted by the following equation:

$${s}_{u}^{m} ( n ) = IDFT \{ {S}_{u} ( k ) \cdot exp ( j2π \frac{m \times Q \cdot k}{{N}_{p}} ) \}$$

### Note: GCL sequence is utilized as reference sequence in the application, but it is possible to adopt the other sequence such as M-sequence.

There are three techniques for sequence index detection and circular shift index namely:

### (1) Coherent detection for both a sequence index and a circular shift index;

### (2) Non-coherent detection for a sequence index and coherent detection for a circular shift index, and

### (3) Non-Coherent detection for both a sequence index and a circular shift index.

In case of the technique (1), any sequence (such as M-sequences) is applicable as a synchronization channel sequence (i.e., reference sequence or preamble) while in the case of the techniques (2) and (3), GCL sequences are preferable due to non-coherent detection of a sequence index.

### (1) Coherent Detection for Both a Sequence Index and a Circular Shift Index

For coherent detection of a sequence index (u) and a circular shift index (m), an estimated channel impulse response is needed. Therefore, another synchronization channel (i.e., another reference sequence or another preamble) is needed for performing channel estimation. FIG. 3 shows the example of the preferred synchronization channel (i.e., preambles or reference sequences) structure. In FIG. 3 the primary synchronization channel sequence (i.e., primary reference sequence or primary preamble) is common among all cells and is used for channel estimation at a receiver. Also circular shift is not applied to the primary synchronization channel. The secondary synchronization channel sequence (i.e., secondary reference sequence or secondary preamble) is cell-specific GCL sequence with cell specific circular shift in the time domain.

Although FIG. 3 shows that the primary synchronization channel and the secondary synchronization channel are time-division-multiplexed (TDM), it is possible to apply the other multiplexing method such as frequency division multiplexing (FDM) of the primary synchronization channel and the secondary synchronization channel. Since a circular shift index is coherently detected, the circular shifted sequences are orthogonal for all circular shift indices even if “Q” is small (e.g., Q=1 or 2).

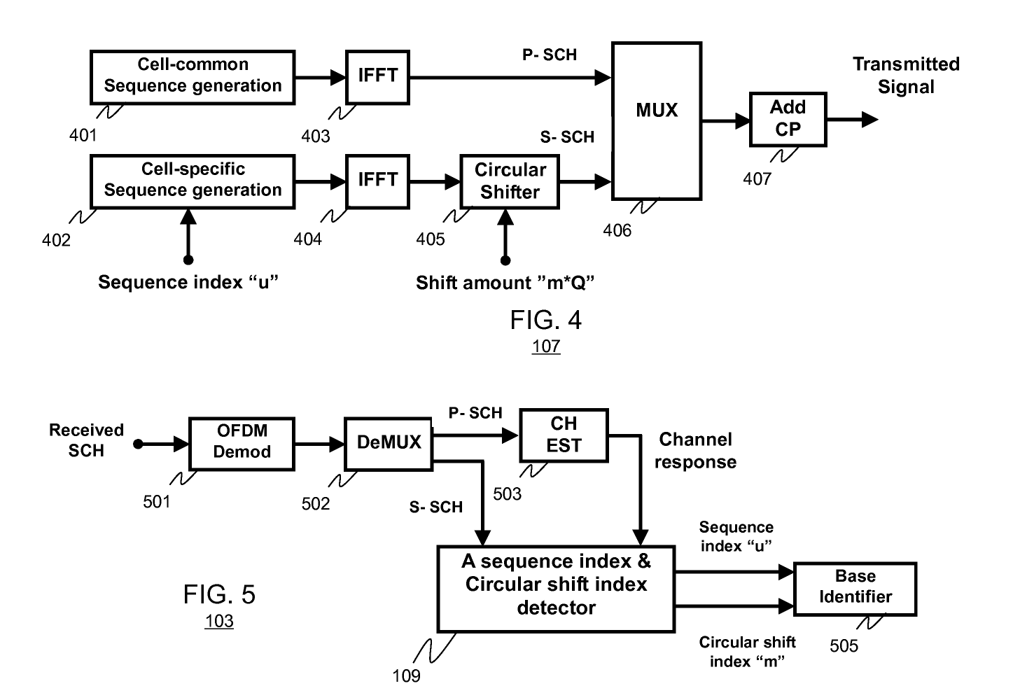

FIG. 4 is a block diagram of a transmitter 107 which is used to transmit a primary synchronization channel and a secondary synchronization channel in the case of techniques (1) and (2). As shown, the transmitter comprises cell-common sequence generator 401 for generating the primary synchronization sequence, cell-specific sequence generator 402 for generating the secondary synchronization sequence, IFFT circuitry 403 and 404, circular shifter 405 for circular shifting the secondary synchronization sequence, multiplexer 406, and optional cyclic prefix adder 407.

During operation, a cell common sequence is generated by generator 401 and is passed to IFFT 403, where the sequence is transformed to a time domain signal. Cell specific GCL sequence with unique sequence index (u) is generated by generator 402 and is passed to IFFT 404, where the sequence is transformed to time domain signal. The cell specific time domain signal is circularly shifted by shifter 405. The shift comprises a unique shift amount (m*Q). The cell-common time domain signal (i.e., P-synchronization channel) and the cell-specific time domain signal (i.e., S-synchronization channel) are passed to multiplexer 406, where those signals are multiplexed. An optional cyclic prefix is added by adder 407 and the circularly-shifted GCL sequence is transmitted by transmission circuitry (not shown). The unique combination of the sequence index (u) and the circular shift index (m) uniquely identifies the transmitter.

FIG. 5 is a block diagram of remote unit 103 which is designed to identify a sequence index (u) and a unique circular shift index (m) via techniques (1) and (2), As shown, remote unit 103 comprises standard OFDM demodulator 501, De-Multiplexer, 502 channel estimator 503, sequence index & a circular shift index detector 109, and base identifier 505.

During operation of the receiver, the received synchronization channel signal is passed to standard OFDM demodulator 501, where any cyclic prefix is removed and then transformed to the received synchronization channel signal in the frequency domain signal by an FFT (not shown). The received synchronization channel in the frequency domain is passed to de-multiplexer 502 and a primary-synchronization channel signal and a secondary synchronization channel signal (GCL signal) are obtained in the frequency domain. The primary synchronization channel signal is passed to channel estimator 503 and channel impulse response is estimated. The secondary synchronization channel signal in the frequency domain and the estimated channel impulse response in the frequency domain are passed to sequence index (u) & circular shift index (m) detector 109. The sequence index u, and the circular shift index m are output to base identifier 505, where base station identification takes place.

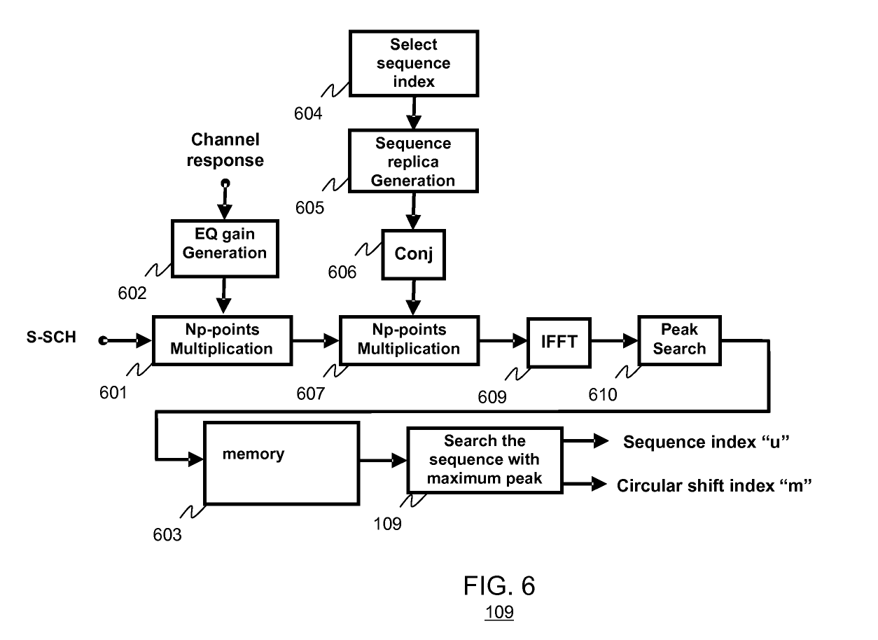

FIG. 6 is a block diagram of sequence index (u) & a circular shift index (m) detector 109 of FIG. 5 when using technique (1). Detector 109 comprises Np-points multiplier 601, equalizing gain generator 602, sequence index selector 604, sequence replica generator 605, Np-points multiplier 607, IFFT 609, peak searcher 610, memory 603 to hold a peak value and its position, and sequence with maximum peak value searcher 608.

During operation equalizing gain generator 602 receives the channel response and generates an equalizing gain in the frequency domain based on the estimated channel impulse response, where Maximum Ratio Combining (MRC), Zero Forcing (ZF) or Minimum Mean Square Error (MMSE) can be utilized as equalizing the gain. The received secondary synchronization GCL signal is passed to Np-points multiplier 601 and is multiplied by the equalizing gain in the frequency domain. A GCL sequence index is selected from all possible indices by selector 604 and is passed to sequence replica generator 605. The GCL sequence replica with the given index is generated by generator 605 and conjugated by circuitry 606. The conjugated sequence and the equalized secondary synchronization channel signal are passed to Np-points multiplier 607 and multiplied in the frequency domain. The output of Np-points multiplier 607 is passed to IFFT 609 and is transformed to a time domain signal. The time domain signal is passed to peak searcher 610, where peak value and its position are detected by peak searcher. The peak value and its position and the sequence index are dumped into memory 603. After peak value and its position search are finished for one sequence index, the operation returns to sequence index selector 604. Peak values and their positions along with sequence indices continue to be dumped into memory 603 until all sequence indices are tried.

After the trial of all sequence indices, the sequence index with maximum peak value is searched in memory by searcher 608. Finally the sequence index (u) and circular shift index (m) are determined. Both the circular shift index (m) and the GCL sequence index (u) are passed to base identifier 505, where an identification of the base unit is determined based on (m) and (u).

### (2) Non-Coherent Detection of the Sequence Index with Coherent Detection of the Circular Shift Index.

In this situation, another synchronization channel (i.e., reference sequence or preamble) is needed for performing channel estimation and the synchronization channel (i.e., preambles or reference sequences) structure (as shown in FIG. 3) is preferable. The primary synchronization channel sequence (i.e., primary reference sequence or primary preamble) is common among all cells and is used for channel estimation at a receiver. Also circular shift is not applied to the primary synchronization channel. The secondary synchronization channel sequence (i.e., secondary reference sequence or secondary preamble) is cell-specific GCL sequence with cell specific circular shift in the time domain as described above. The difference from the technique described above in (1) is that this technique utilizes a “differential demodulator” with simple processing as GCL sequence index identification.

Since a circular shift index is coherently detected, the circular shifted sequences are orthogonal for all circular shift indices even if “Q” circular shift unit amount is enough small (e.g., Q=1 or 2). The transmitter for the technique (2) is same as the transmitter for the technique (1) as shown in FIG. 4. The unique combination of the sequence index (u) and the circular shift index (m) uniquely identifies a base unit. Additionally, the receiver is same as that shown for technique (1) in FIG. 5.

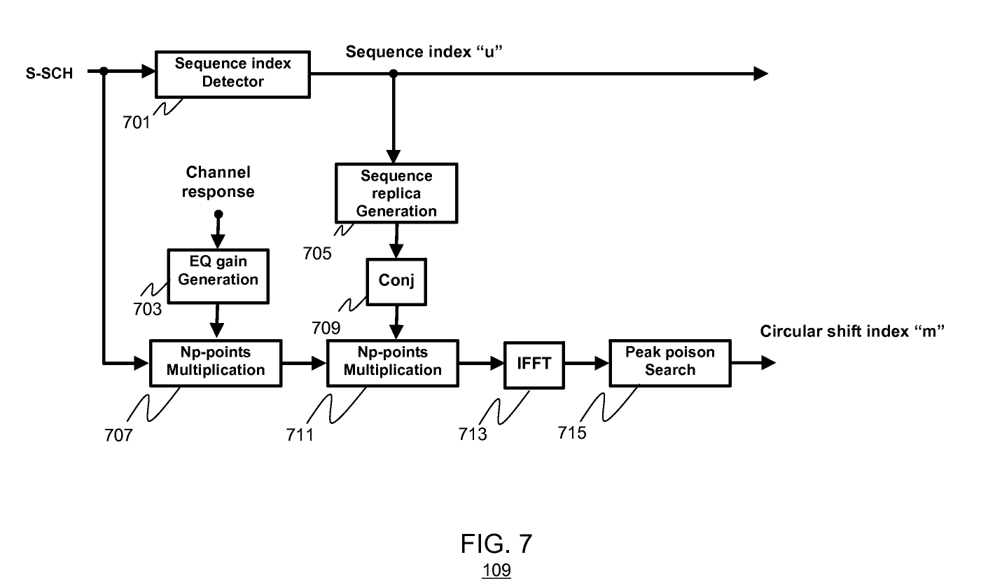

FIG. 7 is a block diagram of a sequence index (u) & a circular shift index (m) detector 109 for non-coherent detection of the sequence index with coherent detection of the circular shift index. Sequence index & circular shift index detector 109 comprises sequence index detector 701, equalizing gain generator 703, Np-points multiplier 707, sequence replica generator 705, Np-points multiplier 711, IFFT 713, and peak position searcher 715.

During operation the received secondary synchronization channel signal in the frequency domain is passed to sequence index detector 701, where the index (u) of the received GCL sequence is determined. Equalizing gain generator 703 generate equalizing gain in the frequency domain based on the estimated channel impulse response, where Maximum Ration Combining (MRC), Zero Forcing (ZF) or Minimum Mean Square Error (MMSE) can be utilized as equalizing gain at equalizing gain generator 703. The received secondary synchronization channel signal is passed to Np-points multiplier 707 and is multiplied by the equalizing gain in the frequency domain. The sequence replica with the index determined by sequence index detector 701 is generated and then is conjugated by circuitry 709. The conjugated sequence and the equalized secondary synchronization channel signal are passed to Np-points multiplier 711 and multiplied in the frequency domain. The output of Np-points multiplier 711 is passed to IFFT 713 and is transformed to a time domain signal. The time domain signal is passed to peak position searcher 715 and the position of peak are detected in the time domain. The detected position of peak is identified as a circular shift index (m). The trial of all possible indices is not needed for a sequence index search unlike the technique of (1) because this technique utilizes sequence index detector, which comprises a “differential demodulator” with simple processing. Both the circular shift index (m) and the GCL sequence index (u) are passed to base identifier, where an identification of the base unit is determined based on (m) and (u).

### (3) Non-Coherent Detection of the Sequence Index with Non-Coherent Detection of the Circular Shift Index.

In this technique both a synchronization channel sequence index and a circular shift index are non-coherently detected. The synchronization channel sequence (i.e., a reference sequence or a preamble) is cell-specific GCL sequence with cell specific circular shift in the time domain. However, this technique does not need an estimated channel response unlike the technique of (1) and (2) because both a sequence index and a circular shift index are non-coherently detected. Therefore, this technique does not need another synchronization channel (i.e., another preamble, another reference sequence) to perform channel estimation besides cell-specific synchronization channel unlike techniques (1) and (2). In fact this technique does not necessarily need to adopt the channel structure as shown in FIG. 3, which has the primary synchronization channel and the secondary synchronization channel. (Note: of course the channel structure as shown in FIG. 3 could be also applied to this technique).

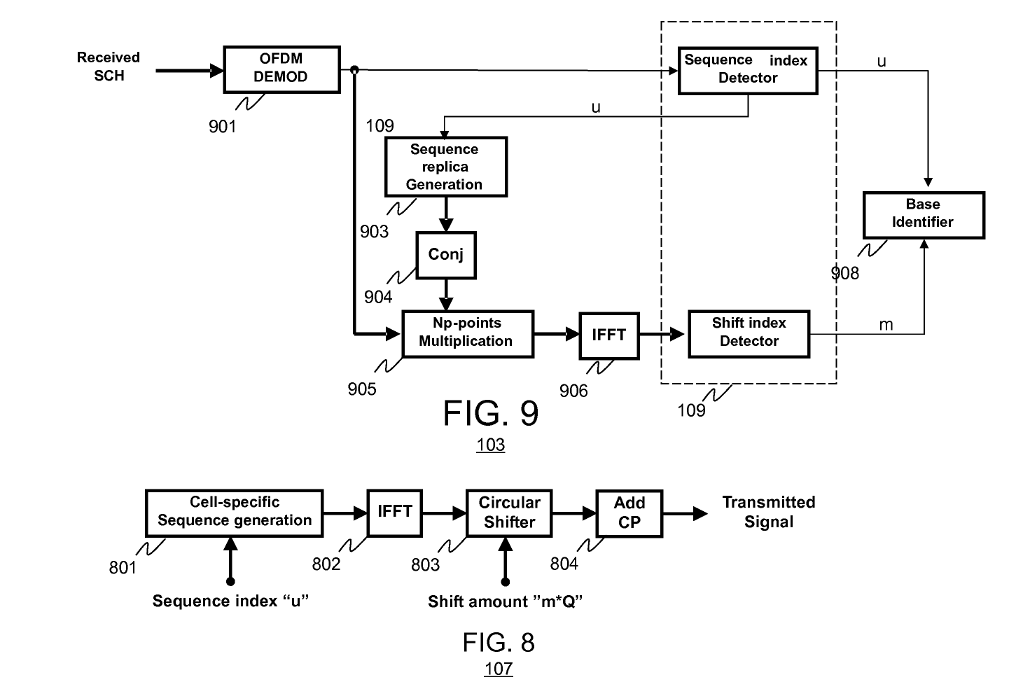

FIG. 8 is a block diagram of a transmitter 107 utilizing technique (3), which is used to transmit a synchronization channel sequence (i.e., a reference sequence or a preamble) having a circular shift of m*Q in time domain, where m is the circular shift index and Q is a circular shift unit amount. As shown, transmitter 107 comprises cell-specific sequence generator 801 for generating synchronization sequence, IFFT circuitry 802, circular shifter 803 for circular shifting the synchronization channel sequence, and optional cyclic prefix adder 804.

The GCL index enters cell specific sequence generator 801 and a GCL sequence with the particular index (u) is output to IFFT circuitry 802, where an IFFT of the GCL sequence takes place and the sequence is transformed to time domain signal. The transformed GCL sequence is output to circular shifter 803 where it is shifted by an amount m*Q in time domain. Particularly, the transformed GCL sequence is shifted such that the first m*Q entries are eliminated from the front of the sequence and added to the end of the sequence.

The circularly-shifted transformed GCL sequence is output to an optional cyclic prefix adder 804 where an optional cyclic prefix is added to the sequence. The circularly-shifted transformed GCL sequence having the optional cyclic prefix is then transmitted via standard OFDM transmit circuitry (not shown). As discussed above, the unique combination of the GCL sequence index (u) and the circular shift index (m) uniquely identifies a base unit. The circular-shifted GCL sequences are orthogonal for all circular shift indices under the assumption that:
“Q” is longer than maximum delayed rays of propagation channel
“M*Q” does not exceed the length of the FFT, where M is the available number of circular shift indices (m).

Because the circular shift index is used to convey cell information, fewer GCL sequences having a shorter length need to be utilized to provide a unique cell ID to a base unit. For example, 64 GCL sequences can be utilized along with 8 circular shift amounts to provide unique identifications for 512 base stations (i.e., (64 GCL indices)*(8 cell IDs)=512 unique cell IDs).

FIG. 9 is a block diagram of remote unit 103 using technique (3) to identify a sequence index (u) and a unique circular shift (m) in case of the technique (3). As shown, remote unit 103 comprises OFDM demodulator 901, sequence index detector and shift index detector 109, sequence replica generator 903, Np-points multiplier 905, IFFT circuitry 906, and base identifier 908.

During operation the received SCH signal is passed to standard OFDM demodulator 901, where cyclic prefix is removed and then is transformed to the received SCH frequency domain signal by FFT (not shown). The received SCH frequency domain signal is passed to sequence index detector 109, where the index (u) of the received GCL sequence is determined. The sequence replica with the index determined by sequence index detector 109 is generated and then is conjugated by circuitry 904. The conjugated sequence and the received SCH signal are passed to Np-points multiplier 905 and multiplied in frequency domain. The output of Np-points multiplier 905 is passed to IFFT circuitry 906 and is transformed to time domain signal. And then the signal in time domain is passed to shift index detector 109, where the circular shift index is determined by searching the position of the window having the maximum power within (m*Q) in time domain. Both the circular shift index (m) and the GCL sequence index (u) are passed to base identifier 908, where an identification of the base unit is determined based on (m) and (u). (i.e., each base station has a unique combination of m and u).

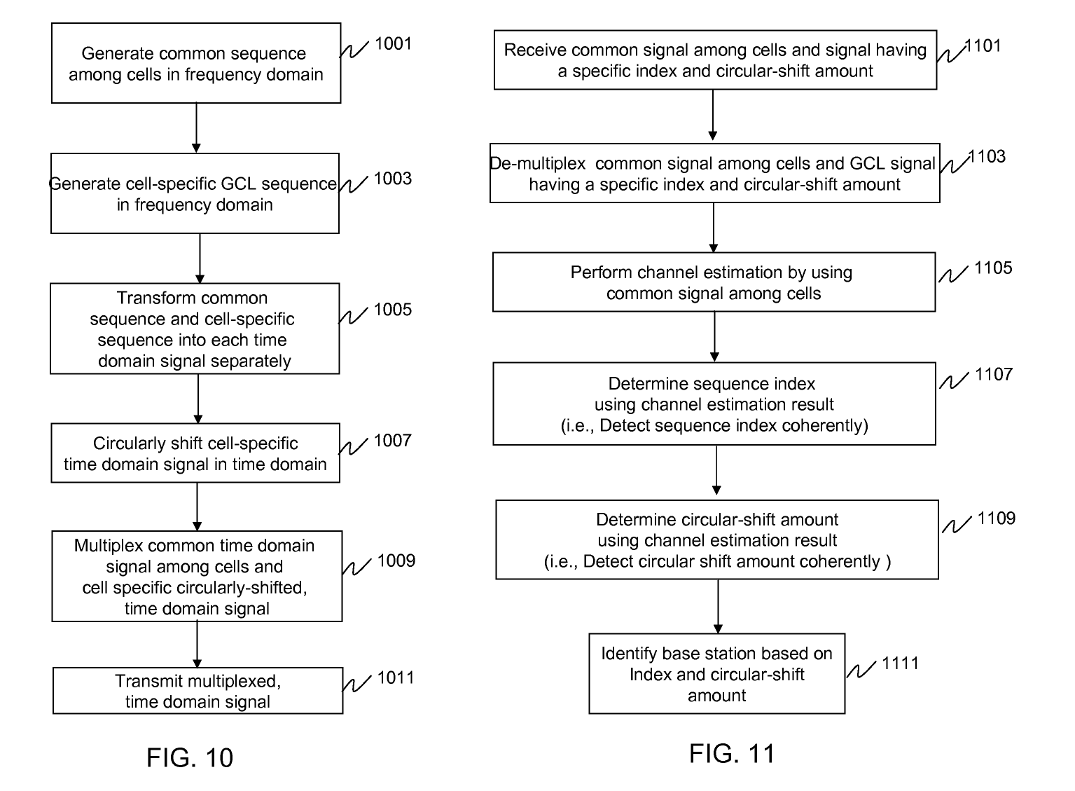

FIG. 10 is a flow chart showing operation of the transmitter shown in FIG. 4 to transmit a cell-specific reference signal. The logic flow begins at step 1001 where a common sequence among cells is generated in frequency domain. At the step 1003, a cell-specific sequence is generated having a particular index “u” in frequency domain. At the step 1005, the common sequence among cells and the cell-specific sequence are separately transformed into common time domain signal among cells and cell-specific time domain signal, respectively by IFFT circuitry. At the step 1007, the cell-specific time domain signal is circularly shifted by an amount m*Q in time domain. At the step 1009, the common time domain signal and cell-specific circular shifted time domain signal are multiplexed. Finally, at step 1011, the multiplexed time domain signal is transmitted.

FIG. 11 is a flow chart showing operation of the remote unit shown in FIG. 5 utilizing technique (1) to receive a cell-specific Generalized Chirp-Like (GCL) sequence via an over-the-air transmission. The logic flow begins at step 1101 where a GCL sequence is received from a transmitter. The GCL sequence comprises a specific index and circular shift amount are received by OFDM demodulator 501. At the step 1103, the common signal among cells and signal having a specific index and circular shift amount are de-multiplexed. At the 1105, channel estimation is performed by using the common signal among cells. At the step 1107, a sequence index is determined with using the channel estimation result by the sequence index and circular shift detector (i.e., the sequence index is coherently detected). At the step 1109, a circular shift amount for the sequence with determined index is determined with using the channel estimation result by the sequence index and circular shift detector (i.e., the circular shift amount is coherently detected). Finally, at step 1111 the index and circular shift amount is passed to base station identification circuitry 505 where the identification of the base station is determined based on the index and the circular shift amount.

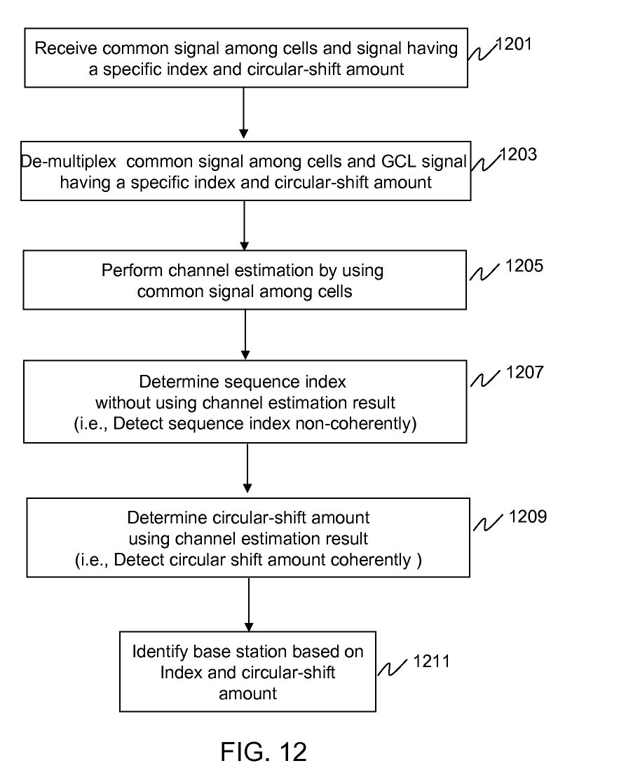

FIG. 12 is a flow chart showing operation of the remote unit of FIG. 5 using technique (2) to receive a cell-specific Generalized Chirp-Like (GCL) sequence via an over-the-air transmission. The logic flow begins at step 1201 where common signal among cells and signal having a specific index and circular shift amount are received by a receiver. At the step 1203, the common signal among cells and signal having a specific index and circular shift amount are de-multiplexed. At the 1205, channel estimation is performed by using the common signal among cells. At the step 1207, a sequence index is determined without using the channel estimation result by the sequence index and circular shift detector (i.e., the sequence index is non-coherently detected.). At the step 1209, a circular shift amount for the sequence with determined index is determined with using the channel estimation result by the sequence index and circular shift detector (i.e., the circular shift amount is coherently detected). Finally, at step 1211 the index and circular shift amount is passed to base station identification circuitry where the identification of the base station is determined based on the index and the circular shift amount.

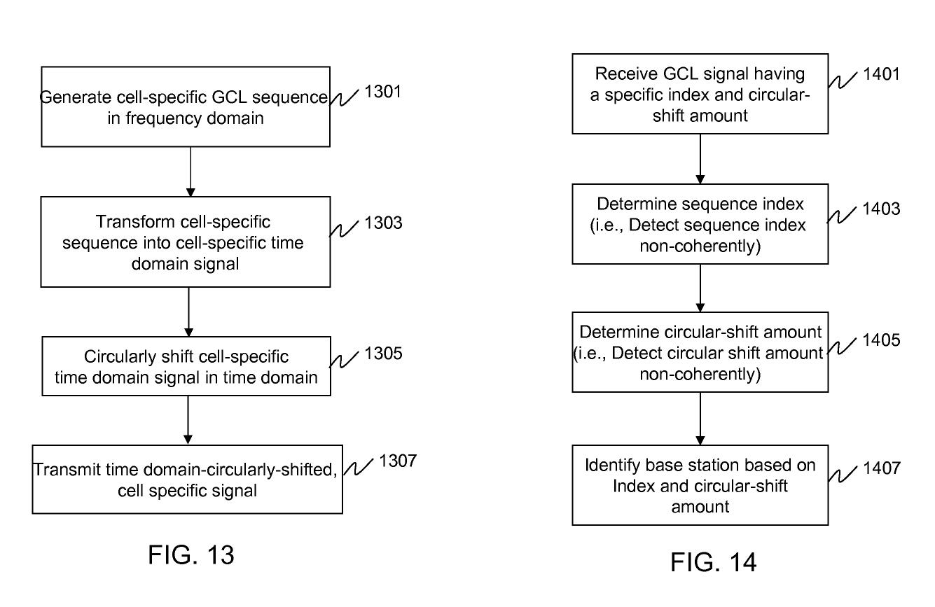

FIG. 13 is a flow chart showing operation of the transmitter shown in FIG. 8 using technique (3) to transmit a cell-specific GCL sequence. The logic flow begins at step 1301 where a cell-specific sequence is generated having a particular index “u” in frequency domain. At the step 1303, the cell-specific sequence is transformed into cell-specific time domain-signal by IFFT circuitry. At step 1305, the cell-specific time domain signal is circularly shifted by an amount m*Q in time domain. Finally, at step 1307, the time domain-circularly-shifted signal is transmitted.

FIG. 14 is a flow chart showing operation of the remote unit of FIG. 9 to receive a cell-specific GCL sequence using technique (3). The logic flow begins at step 1401 where signal having a specific index and circular shift amount is received by a receiver. At step 1403, a sequence index is determined by a sequence index detector (i.e., the sequence index is non-coherently detected). At step 1405 a circular shift amount for the sequence with determined index is determined by the circular shift detector (i.e., the circular shift amount is non-coherently detected). Finally, at step 1407 the index and circular shift amount is passed to base station identification circuitry where the identification of the base station is determined based on the index and the circular shift amount.

While the invention has been particularly shown and described with reference to a particular embodiment, it will be understood by those skilled in the art that various changes in form and details may be made therein without departing from the spirit and scope of the invention. For example, while the above technique of circular shift was utilized to provide unique cell identifications, the circular shift index may be utilized to provide other types of information to the receiver. Such information may include, system bandwidth of the cell, broadcast channel bandwidth of the cell, a number of transmission antenna of the cell (NTXA of a the cell), Node-B (mobile unit) patterns, . . . , etc. It is intended that all such changes come within the scope of the following claims.

1. A method for fast cell search, the method comprising the steps of:
receiving a Generalized Chirp-Like (GCL) sequence from a transmitter;
determining a GCL index from the GCL sequence;
determining a circular shift of a GCL sequence; and
determining a transmitter identification based on the GCL index and the circular shift of the GCL sequence.

2. The method of claim 1 wherein the step of receiving the GCL sequence comprises the step of receiving the GCL sequence via an over-the-air transmission.

3. The method of claim 1 wherein the step of determining the GCL index from the GCL sequence comprises the step of coherently determining the GCL index from the GCL sequence, and wherein the step of determining the circular shift of the GCL sequence comprises the step of coherently determining circular shift of the GCL sequence.

4. The method of claim 1 wherein the step of determining the GCL index from the GCL sequence comprises the step of non-coherently determining the GCL index from the GCL sequence, and wherein the step of determining the circular shift of the GCL sequence comprises the step of coherently determining circular shift of the GCL sequence.

5. The method of claim 1 wherein the step of determining the GCL index from the GCL sequence comprises the step of non-coherently determining the GCL index from the GCL sequence, and wherein the step of determining the circular shift of the GCL sequence comprises the step of non-coherently determining circular shift of the GCL sequence.

6. The method of claim 1 wherein a unique combination of the index and the circular shift uniquely identifies the transmitter.

7. An apparatus comprising:
a receiver receiving a Generalized Chirp-Like (GCL) sequence from a transmitter;
a sequence index and circular shift detector determining a GCL index and a circular shift of the GCL sequence; and
base identification circuitry determining a transmitter identification based on the GCL index and the circular shift of the GCL sequence.

8. The apparatus of claim 7 wherein the GCL sequence is received via an over-the-air transmission.

9. The apparatus of claim 7 wherein the sequence index and circular shift detector coherently determines the GCL index from the GCL sequence, and coherently determines the circular shift of the GCL sequence.

10. The apparatus of claim 7 wherein the sequence index and circular shift detector non-coherently determines the GCL index from the GCL sequence, and coherently determines the circular shift of the GCL sequence.

11. The apparatus of claim 7 wherein the sequence index and circular shift detector non-coherently determines the GCL index from the GCL sequence, and non-coherently determines circular shift of the GCL sequence.

12. The apparatus of claim 7 wherein a unique combination of the index and the circular shift uniquely identifies the transmitter.

13. A method comprising the steps of:
circularly shifting a GCL sequence having a specific index; and
transmitting the circularly-shifted GCL sequence with the specific index, wherein a unique combination of the index and the circular shift uniquely identifies a transmitter.

14. The method of claim 13 further comprising the steps of:
transmitting a primary synchronization channel containing a primary reference sequence; and
transmitting a secondary synchronization channel containing the circularly-shifted GCL sequence.

15. An apparatus comprising:
a circular shifter circularly shifting a GCL sequence having a specific index; and
a transmitter transmitting the circularly-shifted GCL sequence with the specific index, wherein a unique combination of the index and the circular shift uniquely identifies a transmitter.

16. A method for fast cell search, the method comprising the steps of:
receiving a Generalized Chirp-Like (GCL) sequence from a transmitter;
determining a GCL index from the GCL sequence;
determining a circular shift of a GCL sequence; and
determining information from the group consisting of system bandwidth, broadcast channel bandwidth, a number of transmission antennas, and mobile unit patterns based on the GCL index and the circular shift of the GCL sequence.
